(19) United States
(12) Patent Application Publication
(10) Pub. No.: US 2004/0132874 A1
(43) Pub. Date: Jul. 8, 2004

(54) Stabilizer compositions for halogenated polymers, the use thereof and polymers containing said compositions

(76) Inventors: Jurgen Hauk, Freising (DE); Stefan Fokken, Biberbach (DE)

Correspondence Address: CONNOLLY BOVE LODGE & HUTZ LLP, SUITE 800, 1990 M STREET NW, WASHINGTON, DC, 20036-3425, US

(21) Appl. No.: 10/467,867

(22) PCT Filed: Feb. 27, 2002
(86) PCT No.: PCT/EP02/02115

(30) Foreign Application Priority Data
Feb. 27, 2001 (DE) 101 09 366.7

(51) Int. Cl. C08K 5/34; C09K 15/00

(52) U.S. Cl. 524/86; 252/397

(57) ABSTRACT

The present invention relates to stabiliser compositions for halogenated polymers, to polymer compositions comprising such stabiliser compositions and to moulded articles that can be produced using the described stabiliser compositions or polymer compositions.

The present invention relates to stabiliser compositions for halogenated polymers, to polymer compositions comprising such stabiliser compositions and to moulded articles produced using the described stabiliser compositions or polymer compositions.

It is known that halogen-containing plastics have a tendency to undergo undesirable decomposition and breakdown reactions under thermal stress during processing or during long-term use. The breakdown of halogenated polymers, especially in the case of PVC, results in the formation of hydrochloric acid, which is eliminated from the polymer strand, resulting in a discoloured, unsaturated plastics having colour-imparting polyene sequences.

A particular problem in that case is that halogen-containing polymers exhibit the rheological conditions necessary for processing only at a relatively high temperature. At such temperatures, however, in the case of unstabilised polymers the polymer already begins to undergo significant decomposition, which results both in the undesirable colour change described above and in a change in the material properties. Furthermore, the hydrochloric acid freed from non-stabilised, halogen-containing polymers at such a processing temperature can lead to significant corrosion of the processing apparatus. That process plays a particular role when, during the processing of such halogenated polymers to form moulded articles, for example by extrusion, production is interrupted and the polymer mass remains in the extruder for a prolonged period. During that period the above-mentioned decomposition reactions may occur, so that the charge in the extruder is rendered unusable and the extruder may possibly be damaged.

Furthermore, polymers that are subjected to such decomposition have a tendency to adhere to the processing apparatus and the adhering portions are difficult to remove again. The said problems are usually solved by the use of stabilisers which are added to the halogen-containing polymer prior to or during processing. Such known stabilisers include, for example, lead stabilisers, barium stabilisers, cadmium stabilisers, organotin stabilisers and also barium-cadmium, barium-zinc and calcium-zinc stabilisers.

In addition to the problems described herein, which occur in an early phase of the production of moulded articles from halogen-containing polymers, factors important to the in-use properties of such a moulded article over a prolonged period include, however, colour stability and, as far as possible, unchanged material properties. Especially in the case of moulded articles that are exposed to light, fluctuating temperatures or other external influences, as the period of use increases changes occur to the colour and the material properties which may eventually lead to the moulded article's becoming unusable.

The use of the heavy-metal-containing stabilisers known from the prior art is, however, meeting with rejection by the processing industry and by the user on various grounds.

In the past the problem of the initial colour and the problem of colour stability have been counteracted by the use of organic stabiliser combinations with the aim of counteracting the changes in colour and material properties firstly during the processing phase to form the moulded article and secondly during long-term use.

For example, FR-A 2 491 480 describes a stabiliser combination containing a dihydropyridine and a derivative of aminocrotonic acid. A problem experienced with the described stabiliser combination is that its action in respect of the initial colour during processing leaves something to be desired.

DE-A 1 569 056 relates to a stabilised moulding compound. A moulding compound is described which consists of a polymer or copolymer of vinyl chloride and a stabiliser combination of a mono- or di-aromatically substituted urea or thiourea and an organic phosphite. The stabiliser combination can also contain magnesium oxide or magnesium stearate. A problem experienced with the described moulding compound is, however, that its colour stability leaves something to be desired.

German patent specification 746 081 relates to a method of improving the thermal stability of highly polymerised halogen-containing substances. It describes the stabilisation of halogen-containing polymers with agents having an alkaline action together with amines or carbamides which have a mobile hydrogen atom replaceable by alkali. A problem of the described method is, however, that the initial colour of the described highly polymerised halogen-containing substances leaves something to be desired. In addition, the described stabilisers exhibit loss of activity at temperatures above 160° C.

DE-C 36 36 146 relates to a method of stabilising chlorine-containing resins. In the described process, an aminocrotonic acid ester and a metal-ion-free epoxy compound are added to a polymerised resin. A disadvantage of the described method is, however, that the initial colour of the resins does not meet high standards.

DE-C 26 49 924 relates to antistatic footwear. It describes an outer sole for an item of footwear which consists of a vinyl chloride derivative and contains a non-ionic anti-static agent, an ionic antistatic agent and a non-metallic stabiliser. Combinations used are especially derivatives of aminocrotonic acid together with quaternary ammonium complexes, alkylbenzenesulfonate or triethanolamine alkyl sulfate and esters of caprylic acid. A disadvantage of the described compositions is, however, the fact that they do not exhibit a good action even in respect of the initial colour of the halogen-containing plastics stabilised with such compositions.

JP 63010648 (Adeka Argus Chem. Co. Ltd.) relates to a PVC resin which is obtainable by mixing together PVC resin, a glycidyl acrylate resin and a nitrogen-containing compound. Hydroxyethers of aminocrotonic acid, dihydropyridines and urea compounds are described as examples of suitable nitrogen-containing compounds. The described compositions exhibit a lack of stabilisation in respect of the initial colour, however, and do not meet high standards in respect of colour retention.

EP-A 1 046 668 relates to stabiliser combinations for chlorine-containing polymers. It describes combinations of 6-aminouracil derivatives and at least one further compound selected from the group consisting of perchlorate compounds, glycidyl compounds, β-diketones, β-keto esters, dihydropyridines, polydihydropyridines, sterically hindered amines, alkali alumosilicates, hydrotalcites, alkali and alkaline earth hydroxides, alkali and alkaline earth carbonates or carboxylates, antioxidants and lubricants, and also organotin stabilisers. A disadvantage of the described combinations is, however, that the stabiliser combinations lack UV stability during use.

U.S. Pat. No. 5,464,892 relates to a PVC resin composition containing a perchlorate and a metal carboxylate as stabiliser. A disadvantage of the described compositions is the lack of initial colour stabilisation.

U.S. Pat. No. 5,872,166 relates to PVC stabilisers containing an over-based mixture of salts of unsubstituted or alkyl-substituted benzoic acids optionally with one or more aliphatic fatty acids, a carbonate or silicate stabiliser and optionally one or more polyols having from 2 to 10 OH groups. A disadvantage of the described stabiliser is, however, the lack of stabilisation in respect of the initial colour.

EP 0 962 491 A1 relates to the use of cyanoacetylureas for stabilising halogen-containing polymers. A problem experienced with the described cyanoacetylureas is that they have economic and ecological disadvantages because of the number of synthesis steps for their preparation.

There was therefore a need for a stabiliser combination for halogenated polymers that is free of heavy metals but nevertheless provides an excellent initial colour and colour stability. There was a particular need for a stabiliser combination which, in the production of moulded articles from halogen-containing polymers, ensures a good initial colour and which withstands short interruptions in production with the associated increase in thermal stress on the material. Furthermore, there was a need for a stabiliser combination that in a moulded article produced from a halogen-containing polymer also provides good colour retention during long-term use.

The problem underlying the present invention was therefore to provide stabiliser combinations for halogen-containing polymers that satisfy the above-mentioned requirements. The present invention was also based on the problem of providing a method of stabilising halogen-containing polymers. In addition, the present invention was based on the problem of providing polymer compositions having a good initial colour and good colour stability.

The problems underlying the invention are solved by a stabiliser composition, by a method of stabilising halogen-containing polymers and by a polymer composition, as described in the following text.

The present invention relates to a stabiliser composition, at least comprising a compound having a mercapto-functional sp²-hybridised carbon atom, the compound having a mercapto-functional sp²-hybridised carbon atom not being a cyanoacetylurea, and a halogen-containing salt of an oxy acid.

The present invention relates also to a stabiliser composition, at least comprising a compound having a mercapto-functional sp²-hybridised carbon atom and a halogen-containing salt of an oxy acid or a carbazole or at least one carbazole derivative or 2,4-pyrrolidinedione or at least one 2,4-pyrrolidinedione derivative or at least one compound having a structural element of the general formula I

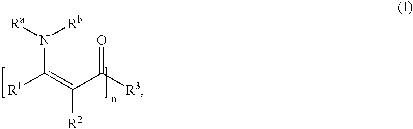

wherein n is a number from 1 to 100,000, the radicals R^{a}, R^{b}, R¹ and R² are each independently of the others hydrogen, an unsubstituted or substituted linear or branched, saturated or unsaturated aliphatic alkyl radical having from 1 to 44 carbon atoms, an unsubstituted or substituted saturated or unsaturated cycloalkyl radical having from 6 to 44 carbon atoms, an unsubstituted or substituted aryl radical having from 6 to 44 carbon atoms or an unsubstituted or substituted aralkyl radical having from 7 to 44 carbon atoms, or the radical R¹ is an unsubstituted or substituted acyl radical having from 2 to 44 carbon atoms or the radicals R¹ and R² are linked to form an aromatic or heterocyclic system and wherein the radical R³ is hydrogen, an unsubstituted or substituted, linear or branched, saturated or unsaturated aliphatic alkyl or alkylene radical or oxyalkyl or oxyalkylene radical or mercaptoalkyl or mercaptoalkylene radical or aminoalkyl or aminoalkylene radical having from 1 to 44 carbon atoms, an unsubstituted or substituted saturated or unsaturated cycloalkyl or cycloalkylene radical or oxycycloalkyl or oxycycloalkylene radical or mercaptocycloalkyl or mercaptocycloalkylene radical or aminocycloalkyl or aminocycloalkylene radical having from 6 to 44 carbon atoms or an unsubstituted or substituted aryl or arylene radical having from 6 to 44 carbon atoms or an ether or thioether radical having from 1 to 20 O or S atoms or O and S atoms, or is a polymer that is bonded to the structural element in brackets by way of O, S, NH, NR^{a} or CH₂C(O), or the radical R³ is so linked to the radical R¹ that in total an unsubstituted or substituted, saturated or unsaturated heterocyclic ring system having from 4 to 24 carbon atoms is formed, the radical R¹ in a ring system with R³ not being NH or NR^{a}, or a mixture of two or more of the mentioned compounds.

A “stabiliser composition” is to be understood in the context of the present invention as being a composition that can be used for the stabilisation of halogen-containing polymers. For achieving that stabilisation effect, a stabiliser composition according to the invention is generally mixed with a halogen-containing polymer to be stabilised and then processed. It is equally possible, however, for a stabiliser composition according to the invention to be mixed with the halogen-containing polymer to be stabilised during processing.

A stabiliser composition according to the invention has at least two constituents. As a first constituent a stabiliser composition according to the invention contains at least one compound having at least one mercapto-functional, sp²-hybridised carbon atom, for example thiourea or a thiourea derivative.

Compounds having at least one mercapto-functional, sp²-hybridised carbon atom that are suitable in the context of the present invention are in principle any compounds having a structural element Z═CZ—SH or a structural element Z₂C═S, it being possible for the two structural elements to be tautomeric forms of a single compound. The sp2-hybridised carbon atom can be a constituent of an unsubstituted or substituted aliphatic compound or a constituent of an aromatic system. Suitable compound types are, for example, thiocarbamic acid derivatives, thiocarbamates, thiocarboxylic acids, thiobenzoic acid derivatives, thioacetone derivatives or thiourea or thiourea derivatives.

When a stabiliser composition according to the invention, in addition to a compound having at least one mercapto-functional, sp²-hybridised carbon atom and a salt of a halogen-containing oxy acid, comprises no compound from the group consisting of carbazoles or carbazole derivatives or 2,4-pyrrolidinediones or 2,4-pyrrolidinedione derivatives or compounds having a structural element of the general formula I

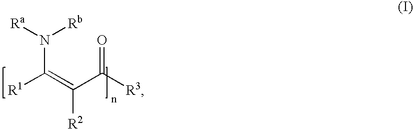

wherein n is a number from 1 to 100,000, the radicals R^{a}, R^{b}, R¹ and R² are each independently of the others hydrogen, an unsubstituted or substituted linear or branched, saturated or unsaturated aliphatic alkyl radical having from 1 to 44 carbon atoms, an unsubstituted or substituted saturated or unsaturated cycloalkyl radical having from 6 to 44 carbon atoms, an unsubstituted or substituted aryl radical having from 6 to 44 carbon atoms or an unsubstituted or substituted aralkyl radical having from 7 to 44 carbon atoms, or the radical R¹ is an unsubstituted or substituted acyl radical having from 2 to 44 carbon atoms or the radicals R¹ and R² are linked to form an aromatic or heterocyclic system and wherein the radical R³ is hydrogen, an unsubstituted or substituted, linear or branched, saturated or unsaturated aliphatic alkyl or alkylene radical or oxyalkyl or oxyalkylene radical or mercaptoalkyl or mercaptoalkylene radical or aminoalkyl or aminoalkylene radical having from 1 to 44 carbon atoms, an unsubstituted or substituted saturated or unsaturated cycloalkyl or cycloalkylene radical or oxycyclalkyl or oxycycloalkylene radical or mercaptocycloalkyl or mercaptocycloalkylene radical or aminocycloalkyl or aminocycloalkylene radical having from 6 to 44 carbon atoms or an unsubstituted or substituted aryl or arylene radical having from 6 to 44 carbon atoms or an ether or thioether radical having from 1 to 20 O or S atoms or O and S atoms, or is a polymer that is bonded to the structural element in brackets by way of O, S, NH, NR^{a} or CH₂C(O), or the radical R³ is so linked to the radical R¹ that in total an unsubstituted or substituted, saturated or unsaturated heterocyclic ring system having from 4 to 24 carbon atoms is formed, the radical R¹ in a ring system with R³ not being NH or NR^{a}, or a mixture of two or more of the mentioned compounds, the stabiliser composition contains as the compound having at least one mercapto-functional, sp²-hybridised carbon atom no compound of the class of the cyanoacetylureas, especially no cyanoacetylureas as described in EP 0 962 491 A1.

Within the scope of a preferred embodiment of the present invention, as the compound having at least one mercapto-functional, sp²-hybridised carbon atom there is used thiourea or a thiourea derivative.

A thiourea derivative is to be understood in the context of the present invention as being a compound of the general formula II

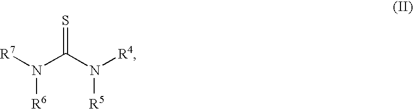

wherein the radicals R⁴ to R⁷ are each independently of the others hydrogen, a linear or branched, saturated or unsaturated, unsubstituted or substituted alkyl radical having from 1 to 24 carbon atoms, a saturated or unsaturated, unsubstituted or substituted cycloalkyl radical having from 6 to 24 carbon atoms or an unsubstituted or substituted aryl radical having from 6 to 24 carbon atoms, an unsubstituted or substituted aralkyl radical having from 7 to 44 carbon atoms or a linear or branched, saturated or unsaturated, unsubstituted or substituted acyl radical having from 1 to 24 carbon atoms, or pairs of two of the radicals R⁴ and R⁵ or R⁶ and R⁷ form a saturated or unsaturated, unsubstituted or substituted cyclic compound having from 4 to about 10 carbon atoms or pairs of two of the radicals R⁷ and R⁴ or R⁷ and R⁵ or R⁶ and R⁴ or R⁶ and R⁵ form a saturated or unsaturated, unsubstituted or substituted homo- or heterocycle having from 2 to about 10 carbon atoms, and in the afore-mentioned cases the radicals not participating in the formation of the cyclic compound may be, each independently of the others, hydrogen, a linear or branched, saturated or unsaturated, unsubstituted or substituted alkyl radical having from 1 to 24 carbon atoms, a linear or branched, saturated or unsaturated, unsubstituted or substituted alkyl radical having from 1 to 24 carbon atoms, a saturated or unsaturated, unsubstituted or substituted cycloalkyl radical having from 6 to 24 carbon atoms or an unsubstituted or substituted aryl radical having from 6 to 24 carbon atoms and the radicals not participating in the formation of the cyclic compound are not bonded to the nitrogen atom by way of —C(O)— groups.

Within the scope of a preferred embodiment, a stabiliser composition according to the invention comprises thiourea or a thiourea derivative, especially a thiourea derivative having sterically bulky aliphatic, cycloaliphatic or aromatic substituents at one or both nitrogen atoms.

It is therefore preferred within the scope of the present invention when a stabiliser composition according to the invention has at least one compound of the general formula II in which at least one of the radicals R⁴ to R⁷ is an aryl radical having at least 6 carbon atoms and at least one of the radicals R⁴ to R⁷ is hydrogen. Within the scope of an especially preferred embodiment of the present invention, a stabiliser composition according to the invention comprises at least one compound of the general formula II in which one of the radicals R⁴ and R⁵ and one of the radicals R⁶ and R⁷ is an aryl radical having at least 6 carbon atoms.

Within the scope of an especially preferred embodiment of the present invention, a stabiliser composition according to the invention comprises, for example, thiourea, phenylthiourea or N,N′-diphenylthiourea or a mixture thereof.

Within the scope of the present invention, a stabiliser composition according to the invention may have only one compound of the general formula II. It is equally possible according to the invention, however, for a stabiliser composition according to the invention to have a mixture of two or more of the above-mentioned compounds of the general formula II.

A stabiliser composition according to the invention contains preferably at least approximately 0.1% by weight thiourea or thiourea derivatives. The upper limit for the content of the mentioned compounds is approximately 80% by weight, but preferably a maximum of approximately 30% by weight. Within the scope of a preferred embodiment of the present invention a stabiliser composition according to the invention contains from approximately 1 to approximately 25% by weight, for example from approximately 3 to approximately 15% by weight or from approximately 5 to approximately 10% by weight, thiourea or thiourea derivatives, especially phenylthiourea or N,N′-diphenylthiourea or a mixture thereof.

Within the scope of a further embodiment of the present invention, a stabiliser composition according to the invention comprises as the compound having at least one mercapto-functional sp²-hybridised carbon atom a mercaptobenzimidazole or a mercaptobenzimidazole derivative of the general formula VII

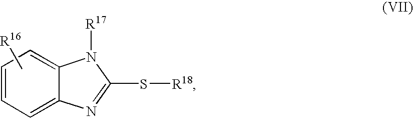

wherein the radicals R¹⁶ and R¹⁷ are each independently of the other hydrogen, a linear or branched, saturated or unsaturated, unsubstituted or substituted alkyl radical having from 1 to 24 carbon atoms or a linear or branched, saturated or unsaturated, unsubstituted or substituted acyl radical having from 2 to 24 carbon atoms, a saturated or unsaturated, unsubstituted or substituted cycloalkyl radical having from 6 to 24 carbon atoms or an unsubstituted or substituted aryl radical having from 6 to 24 carbon atoms and the radical R¹⁸ is hydrogen.

Within the scope of a preferred embodiment of the present invention, a stabiliser composition according to the invention comprises a compound of the general formula VII wherein R¹⁶ is H or F and R¹⁷ is H or C₁₆₋₁₈-acyl.

When a stabiliser composition according to the invention comprises a compound of the general formula VII or a mixture of two or more such compounds, the proportion of that compound or those compounds in the total stabiliser composition is from approximately 0.1 to approximately 50% by weight, preferably from approximately 1 to approximately 20% by weight.

Within the scope of a preferred embodiment of the present invention, a stabiliser composition according to the invention comprising a compound of the general formula VII contains no further stabilisers that contain tin or lead.

Within the scope of a further embodiment of the present invention, a stabiliser composition according to the invention comprises as the compound having at least one sp2-hybridised carbon atom a mercaptobenzothiazole or a mercaptobenzothiazole derivative of the general formula VIII

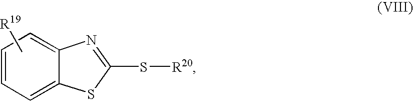

wherein the radical R¹⁹ each independently of the others is hydrogen, a linear or branched, saturated or unsaturated, unsubstituted or substituted alkyl radical having from 1 to 24 carbon atoms or a linear or branched, saturated or unsaturated, unsubstituted or substituted acyl radical having from 2 to 24 carbon atoms, a saturated or unsaturated, unsubstituted or substituted cycloalkyl radical having from 6 to 24 carbon atoms or an unsubstituted or substituted aryl radical having from 6 to 24 carbon atoms and the radical R²⁰ is hydrogen.

Within the scope of a preferred embodiment of the present invention, a stabiliser composition according to the invention comprises a compound of the general formula VIII wherein R¹⁹ is H or F.

When a stabiliser composition according to the invention comprises a compound of the general formula VIII or a mixture of two or more such compounds, the proportion of that compound or those compounds in the total stabiliser composition is from approximately 0.1 to approximately 50% by weight, preferably from approximately 1 to approximately 20% by weight.

Within the scope of a further embodiment of the present invention, a stabiliser composition according to the invention comprises a thiocarbamic acid of the general formula IX

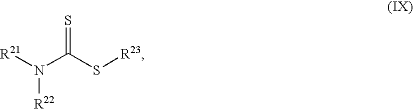

wherein the radicals R²¹, R²² and R²³ are each independently of the others hydrogen, a linear or branched, saturated or unsaturated, unsubstituted or substituted alkyl radical having from 1 to 24 carbon atoms, a linear or branched, saturated or unsaturated, unsubstituted or substituted acyl radical having from 2 to 24 carbon atoms, a saturated or unsaturated, unsubstituted or substituted cycloalkyl radical having from 6 to 24 carbon atoms or an unsubstituted or substituted aryl radical having from 6 to 24 carbon atoms.

Within the scope of a preferred embodiment of the present invention, a stabiliser composition according to the invention comprises a compound of the general formula IX wherein R²¹ or R²² or R²¹ and R²² are H and R²³ is a linear alkyl radical having from 1 to 12 carbon atoms.

When a stabiliser composition according to the invention comprises a compound of the general formula IX or a mixture of two or more such compounds, the proportion of that compound or those compounds in the total stabiliser composition is from approximately 0.1 to approximately 50% by weight, preferably from approximately 1 to approximately 20% by weight.

In addition to a compound having at least one mercapto-functional sp²-hybridised carbon atom, for example a compound according to one of the general formulae II, VII, VIII and IX or a mixture of two or more thereof, a stabiliser composition according to the invention also comprises at least one further compound. As at least one further compound there are suitable, for example, halogen-containing salts of oxy acids, especially the perchlorates. Examples of suitable perchlorates are those of the general formula M(ClO₄)ₙ, wherein M is Li, Na, K, Mg, Ca, Sr, Zn, Al, La or Ce. The index n, according to the valency of M, is the number 1, 2 or 3. The mentioned perchlorate salts can be complexed with alcohols (polyols, cyclodextrins) or ether alcohols or ester alcohols. Ester alcohols include the polyol partial esters. Suitable polyvalent alcohols or polyols include their dimers, trimers, oligomers and polymers, such as di-, tri-, tetra- and poly-glycols, and also di-, tri- and tetra-pentaerythritol or polyvinyl alcohol in various degrees of polymerisation and hydrolysis. As polyol partial esters preference is given to glycerol monoethers and glycerol monothioethers. Also suitable are sugar alcohols and thio sugars.

The perchlorate salts can be used in various common delivery forms, for example in the form of a salt or an aqueous solution supported on a suitable carrier material, such as PVC, calcium silicate, zeolites or hydrotalcites, or bonded by chemical reaction into a hydrotalcite. A combination of sodium perchlorate and calcium silicate that is suitable as a constituent of the stabiliser composition according to the invention can be obtained, for example, by combining an aqueous solution of sodium perchlorate (content of sodium perchlorate about 60% or more) with calcium silicate, for example with a synthetic, amorphous calcium silicate. Suitable particle sizes for the calcium silicate that is suitable for use are, for example, from approximately 0.1 to approximately 50 μm, for example from approximately 1 to approximately 20 μm. Suitable perchlorate-containing delivery forms are described, for example, in U.S. Pat. No. 5,034,443, reference being expressly made to the perchlorate-containing delivery forms disclosed therein and that disclosure being regarded as part of the disclosure of this text.

Further suitable delivery forms are mentioned, for example, in EP-A 394,547, EP-A 457,471 and WO 94/24200, reference being expressly made to the suitable delivery forms disclosed therein and that disclosure being regarded as part of the disclosure of this text.

In the context of the present invention, a stabiliser composition according to the invention can comprise an appropriate salt of a halogen-containing oxy acid in an amount of from approximately 0.1 to approximately 40% by weight, for example from approximately 1 to approximately 35% by weight, especially from approximately 10 to approximately 20% by weight, in each case in dependence upon the delivery form. Based on the content of anions of the halogen-containing oxy acid, for example based on the content of perchlorate anions, the content is, for example, from approximately 0.01 to approximately 20% by weight, especially from approximately 1 to approximately 10% by weight.

Examples of suitable further constituents of the stabiliser compositions according to the invention are carbazole and carbazole derivatives and mixtures of two or more thereof.

“Carbazole and carbazole derivatives” are to be understood in the context of the present invention as being compounds of the general formula III

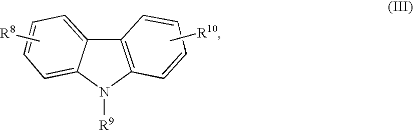

wherein the radicals R⁸, R⁹ and R¹⁰ are each independently of the others hydrogen, a linear or branched, saturated or unsaturated, unsubstituted or substituted alkyl radical having from 1 to 24 carbon atoms, a saturated or unsaturated, unsubstituted or substituted cycloalkyl radical having from 6 to 24 carbon atoms or an unsubstituted or substituted aryl radical having from 6 to 24 carbon atoms.

When a stabiliser composition according to the invention comprises a compound of the general formula III or a mixture of two or more such compounds, the proportion of that compound or those compounds in the total stabiliser composition is from approximately 0.1 to approximately 40% by weight, preferably from approximately 1 to approximately 20% by weight.

Within the scope of a further embodiment of the present invention, a stabiliser composition according to the invention comprises a 2,4-pyrrolidinedione or a 2,4-pyrrolidinedione derivative. “2,4-Pyrrolidinedione” or “a 2,4-pyrrolidinedione derivative” is to be understood in the context of the present invention as being a compound of the general formula IV

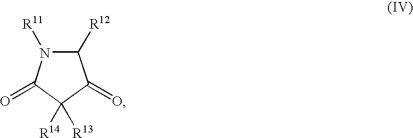

wherein the radicals R¹¹, R¹², R¹³ and R¹⁴ are each independently of the others hydrogen, a linear or branched, saturated or unsaturated, unsubstituted or substituted alkyl radical having from 1 to 24 carbon atoms, a saturated or unsaturated, unsubstituted or substituted cycloalkyl radical having from 6 to 24 carbon atoms or an unsubstituted or substituted aryl radical having from 6 to 24 carbon atoms.

Within the scope of a preferred embodiment of the present invention, a stabiliser composition according to the invention comprises a compound of the general formula IV wherein R¹¹ is phenyl, R¹² is acetyl and R¹³ and R¹⁴ are hydrogen.

When a stabiliser composition according to the invention comprises a compound of the general formula IV or a mixture of two or more such compounds, the proportion of that compound or those compounds in the total stabiliser composition is from approximately 0.1 to approximately 40% by weight, preferably from approximately 1 to approximately 20% by weight.

Likewise suitable as a constituent of the stabiliser compositions according to the invention are compounds having a structural element of the general formula I

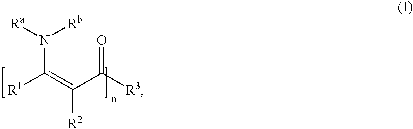

wherein n is a number from 1 to 100,000, the radicals R^{a}, R^{b}, R¹ and R² are each independently of the others hydrogen, an unsubstituted or substituted linear or branched, saturated or unsaturated aliphatic alkyl radical having from 1 to 44 carbon atoms, an unsubstituted or substituted saturated or unsaturated cycloalkyl radical having from 6 to 44 carbon atoms, an unsubstituted or substituted aryl radical having from 6 to 44 carbon atoms or an unsubstituted or substituted aralkyl radical having from 7 to 44 carbon atoms or the radical R¹ is an unsubstituted or substituted acyl radical having from 2 to 44 carbon atoms or the radicals R¹ and R² are linked to form an aromatic or heterocyclic system and wherein the radical R³ is hydrogen, an unsubstituted or substituted, linear or branched, saturated or unsaturated aliphatic alkyl or alkylene radical or oxyalkyl or oxyalkylene radical or mercaptoalkyl or mercaptoalkylene radical or aminoalkyl or aminoalkylene radical having from 1 to 44 carbon atoms, an unsubstituted or substituted saturated or unsaturated cycloalkyl or cycloalkylene radical or oxycycloalkyl or oxycycloalkylene radical or mercaptocycloalkyl or mercaptocycloalkylene radical or aminocycloalkyl or aminocycloalkylene radical having from 6 to 44 carbon atoms or an unsubstituted or substituted aryl or arylene radical having from 6 to 44 carbon atoms or an ether or thioether radical having from 1 to 20 O or S atoms or O and S atoms, or is a polymer that is bonded to the structural element in brackets by way of O, S, NH, NR^{a} or CH₂C(O), or the radical R³ is so linked to the radical R¹ that in total an unsubstituted or substituted, saturated or unsaturated heterocyclic ring system having from 4 to 24 carbon atoms is formed, the radical R¹ in a ring system with R³ not being NH or NR^{a}, or a mixture of two or more of the mentioned compounds.

Within the scope of a preferred embodiment of the present invention, as the compound of the general formula I there is used a compound based on an α,β-unsaturated β-aminocarboxylic acid, especially a compound based on β-aminocrotonic acid. Especially suitable are the esters or thioesters of corresponding aminocarboxylic acids with monovalent or polyvalent alcohols or mercaptans wherein X in each of the mentioned cases is O or S.

When the radical R³ together with X is an alcohol or mercaptan radical, such a radical can be formed, for example, from methanol, ethanol, propanol, isopropanol, butanol, 2-ethylhexanol, isooctanol, isononanol, decanol, lauryl alcohol, myristyl alcohol, palmityl alcohol, stearyl alcohol, ethylene glycol, propylene glycol, 1,3-butanediol, 1,4-butanediol, 1,6-hexanediol, 1,10-decanediol, diethylene glycol, thio-diethanol, trimethylolpropane, glycerol, tris(2-hydroxymethyl) isocyanurate, triethanolamine, pentaerythritol, di-trimethylolpropane, diglycerol, sorbitol, mannitol, xylitol, di-pentaerythritol and also the corresponding mercapto derivatives of the mentioned alcohols.

Within the scope of an especially preferred embodiment of the present invention, as the compound of the general formula I there is used a compound in which R¹ is a linear alkyl radical having from 1 to 4 carbon atoms, R² is hydrogen and R³ is a linear or branched, saturated, mono- to hexa-valent alkyl or alkylene radical having from 2 to 12 carbon atoms or a linear, branched or cyclic 2- to 6-valent ether alcohol radical or thioether alcohol radical.

Suitable compounds of the general formula I include, for example, β-aminocrotonic acid stearyl ester, 1,4-butanediol di(β-aminocrotonic acid) ester, thio-diethanol-β-aminocrotonic acid ester, trimethylolpropane tri-β-aminocrotonic acid ester, pentaerythritol-tetra-β-aminocrotonic acid ester, dipentaerythritol-hexa-β-aminocrotonic acid ester and the like. The mentioned compounds can be present in a stabiliser composition according to the invention alone or as a mixture of two or more thereof.

Also suitable in the context of the present invention as compounds of the general formula I are aminouracil compounds of the general formula V

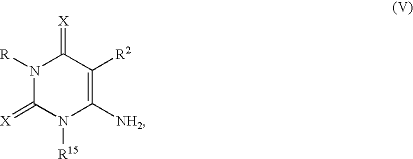

wherein the radicals R and R² have the meanings already given above and the radical R¹⁵ is hydrogen, an unsubstituted or substituted linear or branched, saturated or unsaturated aliphatic hydrocarbon radical having from 1 to 44 carbon atoms, an unsubstituted or substituted saturated or unsaturated cycloaliphatic hydrocarbon radical having from 6 to 44 carbon atoms or an unsubstituted or substituted aromatic hydrocarbon radical having from 6 to 44 carbon atoms.

The compound according to formula V thus falls within the scope of the compounds according to formula I, wherein n in the general formula I is 1 and the radicals R¹ and R³ according to the general formula I are linked to form the structural element of the general formula VI

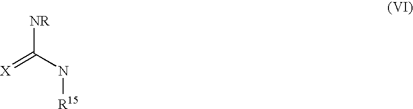

wherein X is S or O. R¹ in the case of a compound of the general formula V is therefore N—R¹⁵, while R³ is —RN—C═X and the two radicals are covalently linked by way of a N—C bond to form a heterocyclic ring.

In the context of the present invention it is preferable to use compounds of the general formula V wherein R² is hydrogen.

Within the scope of a further preferred embodiment of the present invention, in the stabiliser compositions according to the invention there are used compounds of the general formula V wherein R and R¹⁵ are a linear or branched alkyl radical having from 1 to 6 carbon atoms, for example methyl, ethyl, propyl, butyl, pentyl or hexyl, an OH-group-substituted linear or branched alkyl radical having from 1 to 6 carbon atoms, for example hydroxymethyl, hydroxyethyl, hydroxypropyl, hydroxybutyl, hydroxypentyl or hydroxyhexyl, an aralkyl radical having from 7 to 9 carbon atoms, for example benzyl, phenylethyl, phenylpropyl, dimethylbenzyl or phenylisopropyl, it being possible for the mentioned aralkyl radicals to be substituted, for example, by halogen, hydroxy or methoxy, or an alkenyl radical having from 3 to 6 carbon atoms, for example vinyl, alkyl, methallyl, 1-butenyl or 1-hexenyl.

Within the scope of a preferred embodiment of the present invention, in the stabiliser compositions according to the invention there are used compounds of the general formula V wherein R and R¹⁵ are hydrogen, methyl, ethyl, n-propyl, isopropyl, n-, iso-, sec- or tert-butyl.

Also suitable as compounds of the general formula I are, for example, compounds in which the radicals R¹ and R² are linked to form an aromatic or heteroaromatic system, for example aminobenzoic acid, aminosalicylic acid or aminopyridinecarboxylic acid and suitable derivatives thereof.

Within the scope of a preferred embodiment of the present invention, a stabiliser composition according to the invention comprises a compound of the general formula I or a mixture of two or more compounds of the general formula I, for example a compound of the general formula V, in an amount of from approximately 0.1 to approximately 99.5% by weight, especially from approximately 5 to approximately 50% by weight or from approximately 5 to approximately 25% by weight.

Within the scope of a further preferred embodiment of the present invention, a stabiliser composition according to the invention comprises at least one compound of the general formula II and a halogen-containing salt of an oxy acid, especially a perchlorate, or a mixture of two or more such salts, or at least one compound of the general formula II and a compound of the general formula I or a mixture of two or more such compounds of the general formula I, or a compound of the general formula I and a halogen-containing salt of an oxy acid or a mixture of two or more such salts and a compound of the general formula I or a mixture of two or more such compounds.

Stabiliser compositions that are suitable according to the invention comprise, for example,

from approximately 30 to approximately 70% by weight of a compound having at least one mercapto-functional sp²-hybridised carbon atom, especially thiourea or a thiourea derivative of the general formula II, or a mixture of two or more such compounds, and

from approximately 30 to approximately 70% by weight of a halogen-containing salt of a peroxy acid or a mixture of two or more such salts,

or

from approximately 30 to approximately 70% by weight of a compound having at least one mercapto-functional sp²-hybridised carbon atom, especially thiourea or a thiourea derivative of the general formula II, or a mixture of two or more such compounds and

from approximately 30 to approximately 70% by weight of a compound having a structural element of the general formula I or a mixture of two or more such compounds, especially a compound based on β-aminocrotonic acid or a mixture of two or more such compounds

or

from approximately 20 to approximately 60% by weight of a compound having at least one mercapto-functional sp²-hybridised carbon atom, especially thiourea or a thiourea derivative of the general formula II, or a mixture of two or more such compounds and

from approximately 20 to approximately 60% by weight of a halogen-containing salt of a peroxy acid or a mixture of two or more such salts and

from approximately 20 to approximately 60% by weight of a compound having a structural element of the general formula I or a mixture of two or more such compounds, especially a compound based on β-aminocrotonic acid or a mixture of two or more such compounds.

Within the scope of a further embodiment of the present invention, a stabiliser composition according to the invention may also comprise additives.

Suitable additives are, for example, epoxy compounds. Examples of such epoxy compounds are epoxidised soybean oil, epoxidised olive oil, epoxidised linseed oil, epoxidised castor oil, epoxidised groundnut oil, epoxidised maize oil, epoxidised cottonseed oil, and also glycidyl compounds.

Glycidyl compounds contain a glycidyl group that is bonded directly to a carbon, oxygen, nitrogen or sulfur atom. Glycidyl or methylglycidyl esters are obtainable by reaction of a compound having at least one carboxyl group in the molecule and epichlorohydrin or glycerol dichlorohydrin or methyl-epichlorohydrin. The reaction is advantageously carried out in the presence of bases.

As compounds having at least one carboxyl group in the molecule there can be used, for example, aliphatic carboxylic acids. Examples of such carboxylic acids are glutaric acid, adipic acid, pimelic acid, suberic acid, azelaic acid, sebacic acid or dimerised or trimerised linoleic acid, acrylic acid, methacrylic acid, caproic acid, caprylic acid, lauric acid, myristic acid, palmitic acid, stearic acid or pelargonic acid and also the mono- or poly-carboxylic acids mentioned hereinbelow. Also suitable are cycloaliphatic carboxylic acids, such as cyclohexanecarboxylic acid, tetrahydrophthalic acid, 4-methyltetrahydrophthalic acid, hexahydrophthalic acid, endomethylenetetrahydrophthalic acid or 4-methylhexahydrophthalic acid. Also suitable are aromatic carboxylic acids, such as benzoic acid, phthalic acid, isophthalic acid, trimellitic acid or pyromellitic acid.

Glycidyl ethers or methylglycidyl ethers can be obtained by reaction of a compound having at least one free alcoholic OH group or a phenolic OH group and a suitably substituted epichlorohydrin under alkaline conditions or in the presence of an acidic catalyst and subsequent alkali treatment. Ethers of this type are derived, for example, from acyclic alcohols, such as ethylene glycol, diethylene glycol or higher poly(oxyethylene) glycols, propane-1,2-diol or poly(oxypropylene) glycols, butane-1,4-diol, poly(oxytetramethylene) glycols, pentane-1,5-diol, hexane-1,6-diol, hexane-2,4,6-triol, glycerol, 1,1,1-trimethylolpropane, bis-trimethylolpropane, pentaerythritol, sorbitol, and also from polyepichlorohydrins, butanol, amyl alcohol, pentanol, and also from monofunctional alcohols, such as isooctanol, 2-ethylhexanol, isodecanol or technical alcohol mixtures, for example technical fatty alcohol mixtures.

Suitable ethers are also derived from cycloaliphatic alcohols, such as 1,3- or 1,4-dihydroxycyclohexane, bis(4-hydroxycyclohexyl)methane, 2,2-bis(4-hydroxycyclohexyl)propane or 1,1-bis(hydroxymethyl)cyclohexan-3-ene, or they have aromatic nuclei, such as N,N-bis(2-hydroxyethyl)aniline. Suitable epoxy compounds can also be derived from mononuclear phenols, for example from phenol, resorcinol or hydroquinone, or they are based on polynuclear phenols, such as bis(4-hydroxyphenyl)methane, 2,2-bis(4-hydroxyphenyl)propane, 2,2-bis(3,5-dibromo-4-hydroxyphenyl)propane, 4,4′-dihydroxydiphenylsulfones, or on condensation products of phenol with formaldehyde, for example phenol novolaks, obtained under acidic conditions.

Further terminal epoxides suitable as additives in the context of the present invention are, for example, glycidyl-1-naphthyl ether, glycidyl-2-phenyl phenyl ether, 2-diphenylglycidyl ether, N-(2,3-epoxypropyl)phthalimide or 2,3-epoxypropyl-4-methoxyphenyl ether.

Also suitable are N-glycidyl compounds, such as are obtainable by dehydrochlorination of the reaction products of epichlorohydrin with amines containing at least one amino hydrogen atom. Such amines are, for example, aniline, N-methylaniline, toluidine, n-butylamine, bis(4-aminophenyl)methane, m-xylylenediamine or bis(4-methylaminophenyl)methane.

Likewise suitable are S-glycidyl compounds, for example di-S-glycidyl ether derivatives, that are derived from dithiols, such as ethane-1,2-dithiol or bis(4-mercaptomethylphenyl) ether.

Especially suitable epoxy compounds are described, for example, on pages 3 to 5 of EP-A 1 046 668, reference being expressly made to the disclosure contained therein, which is to be regarded as part of the disclosure of this text.

Also suitable as additives in the context of the present invention are 1,3-dicarbonyl compounds, especially the β-diketones and β-keto esters. Suitable in the context of the present invention are dicarbonyl compounds of the general formula R′C(O)CHR″—C(O)R′″, as described, for example, on page 5 of EP 1 046 668, to which reference is expressly made especially in respect of the radicals R′, R″ and R′″ and the disclosure of which is regarded as being part of the diclosure of this text. Especially suitable are, for example, acetyl acetone, butanoyl acetone, heptanoyl acetone, stearoyl acetone, palmitoyl acetone, lauroyl acetone, 7-tert-nonylthioheptanedione-2,4, benzoyl acetone, dibenzoylmethane, lauroylbenzoylmethane, palmitoylbenzoylmethane, stearoylbenzoylmethane, isooctylbenzoylmethane, 5-hydroxycapronylbenzoylmethane, tribenzoylmethane, bis(4-methylbenzoyl)methane, benzoyl-p-chlorobenzoylmethane, bis(2-hydroxybenzoyl)methane, 4-methoxybenzoylbenzoylmethane, bis(4-methoxybenzoyl)methane, benzoylformylmethane, benzoylacetylphenylmethane, 1-benzoyl-1-acetylnonane, stearoyl-4-methoxybenzoylmethane, bis(4-tert-butylbenzoyl)methane, benzoylphenylacetylmethane, bis(cyclohexanoyl)methane, dipivaloylmethane, 2-acetylcyclopentanone, 2-benzoylcyclopentanone, diacetoacetic acid methyl, ethyl, butyl, 2-ethylhexyl, dodecyl or octadecyl ester and also propionyl or butyryl acetic acid esters having from 1 to 18 carbon atoms, and also stearoyl acetic acid ethyl, propyl, butyl, hexyl or octyl esters or polynuclear β-keto esters, as described in EP-A 433 230, to which reference is expressly made, or dehydracetic acid and also the zinc, magnesium or alkali salts thereof or the alkali, alkaline earth or zinc chelates of the mentioned compounds insofar as they exist.

1,3-Diketo compounds can be present in a stabiliser composition according to the invention in an amount of up to approximately 20% by weight, for example up to approximately 10% by weight.

Polyols are also suitable as additives in the context of the stabiliser composition according to the invention. Suitable polyols are, for example, pentaerythritol, dipentaerythritol, tripentaerythritol, bistrimethylolpropane, inositol, polyvinyl alcohol, bistrimethylolethane, trimethylolpropane, sorbitol, maltitol, isomaltitol, lactitol, lycasine, mannitol, lactose, leucrose, tris(hydroxymethyl) isocyanurate, palatinite, tetramethylolcyclohexanol, tetramethylolcyclopentanol, tetramethylolcycloheptanol, glycerol, diglycerol, polyglycerol, thiodiglycerol or 1-0-α-D-glycopyranosyl-D-mannitol dihydrate.

The polyols suitable as additives can be present in a stabiliser composition according to the invention in an amount of up to approximately 30% by weight, for example up to approximately 10% by weight.

Also suitable as additives are, for example, sterically hindered amines, such as those mentioned on pages 7 to 27 of EP-A 1 046 668. Reference is expressly made to the sterically hindered amines disclosed therein, the compounds mentioned therein being regarded as part of the disclosure of this text.

The sterically hindered amines suitable as additives can be present in a stabiliser composition according to the invention in an amount of up to approximately 30% by weight, for example up to approximately 10% by weight.

Also suitable as additives in the stabiliser compositions according to the invention are hydrotalcites, zeolites and alkali alumocarbonates. Suitable hydrotalcites, zeolites and alkali alumocarbonates are described, for example, on pages 27 to 29 of EP-A 1 046 668, on pages 3, 5 and 7 of EP-A 256 872, on pages 2 and 3 of DE-C 41 06 411 and on pages 2 and 3 of DE-C 41 06 404. Reference is expressly made to those specifications, and their disclosure at the indicated places is regarded as being part of the disclosure of this text.

The hydrotalcites, zeolites and alkali alumocarbonates suitable as additives can be present in a stabiliser composition according to the invention in an amount of up to approximately 50% by weight, for example up to approximately 30% by weight.

Also suitable as additives in the context of the stabiliser compositions according to the invention are, for example, hydrocalumites of the general formula X

M²⁺₍₂₊ₓ₎Al³⁺_{(1+y)}(OH)_{(6+z)}A^{k-}ₐ[Bₙ]^{nl}_{b}* mH₂O (X),

wherein M is calcium, magnesium or zinc or a mixture of two or more thereof, A is a k-valent inorganic or organic acid anion, k is 1, 2 or 3, B is an inorganic or organic acid anion other than A, n is a whole number ≧1 and, when is n>1, indicates the degree of polymerisation of the acid anion, and l is 1, 2, 3 or 4 and indicates the valency of the acid anion, where, for n=1, l is 2, 3 or 4 and, for n>1, l indicates the valency of the individual monomer units of the polyanion and is 1, 2, 3 or 4 and nl indicates the total valency of the polyanion, and the following rules apply to the parameters x, y, a, b, n, z, and k:

0≦x≦0.6,

0≦y<0.4, and where either x=0 or y=0,

0<a<0.8/n and

z=1+2x+3y−ka−n/b.

Within the scope of a preferred embodiment of the present invention, as additives there are used compounds of the general formula X wherein M is calcium, which may be in admixture with magnesium or zinc or magnesium and zinc.

In the general formula X, A is a k-valent inorganic or organic acid anion, wherein k is 1, 2 or 3. Examples of acid anions present in the context of hydrocalumites suitable for use according to the invention are halide ions, SO₃²⁻, SO₄²⁻, S₂O₃²⁻, S₂O₄²⁻, HPO₃²⁻, PO₄³⁻, CO₃²⁻, alkyl and dialkyl phosphates, alkyl mercaptides and alkyl sulfonates, wherein the alkyl groups may be identical or different, straight-chain, branched or cyclic and preferably have from 1 to about 20 carbon atoms. Also suitable as acid anions A are the anions of optionally functionalised di-, tri- or tetra-carboxylic acids, such as maleate, phthalate, aconitate, trimesate, pyromellitate, maleate, tartrate, citrate and also anions of the isomeric forms of hydroxyphthalic acid or hydroxymesic acid. Within the scope of a preferred embodiment of the present invention, A is an inorganic acid anion, especially a halide ion, for example F⁻, Cl⁻ or Br⁻, preferably Cl⁻.

In the general formula X, B is an acid anion other than A. For the case where n in the general formula X is the number 1, the letter B denotes a 1-valent inorganic or organic acid anion, wherein 1 is the number 2, 3 or 4. Examples of acid anions B present in the context of compounds of the general formula X suitable for use according to the invention are, for example, O²⁻, SO₃²⁻, SO₄²⁻, S₂O₃²⁻, S₂O₄²⁻, HPO₃²⁻, PO₄³⁻, CO₃²⁻, alkyl and dialkyl phosphates, alkyl mercaptides and alkyl sulfonates, wherein the alkyl groups may be identical or different, straight-chained or branched or cyclic and preferably have from 1 to about 20 carbon atoms. Also suitable as acid anions A are the anions of optionally functionalised di-, tri- or tetra-carboxylic acids, such as maleate, phthalate, aconitate, trimesate, pyromellitate, maleate, tartrate, citrate, and also anions of the isomeric forms of hydroxyphthalic acid or hydroxymesic acid. B in the context of the present invention in formula VII is preferably a borate or an anion of an optionally functionalised di-, tri- or tetra-carboxylic acid. Special preference is given to carboxylic acid anions and anions of hydroxycarboxylic acids having at least two carboxyl groups, very special preference being given to citrates.

For the case where n in the general formula X is a number greater than 1, the term [Bₙ]^{nl-} denotes an inorganic or organic polyanion having a degree of polymerisation n and the valency 1 of the individual monomer units of the polyanion with the total valency nl, wherein l is equal to or greater than 1. Examples of suitable polyanions [Bₙ]^{nl-} are polyacrylates, polycarboxylates, polyborates, polysilicates, polyphosphates and polyphosphonates.

In all the above-mentioned cases, the acid anions A and B can be present in any desired ratio a/b in the compounds of the general formula X.

The compounds of the general formula X are not compounds having a layered structure of the hydrotalcite or hydroalumite type but a physical mixture of M²⁺/aluminium oxide hydrates with salts of divalent metals. X-ray diffractograms of the compounds of the general formula X used in the composition according to the invention clearly show that they are not discrete crystalline compounds of a known type but mixtures that are amorphous to X-rays.

For the preparation of the compounds according to the general formula X, solutions or suspensions of oxidic forms of the desired cations (e.g. NaAlO₂, Ca(OH)₂, Zn(OH)₂, Al(OH)₃) can, following known procedures, be mixed with solutions or suspensions of salts or the corresponding acids of the desired anions and reacted at temperatures of from 40 to 95° C., it being possible for the reaction times to be varied between 15 and 300 minutes.

When surface-treatment of the reaction products is desired, the surface-treatment medium can be added directly to the reaction products and the product can be separated from the mother liquor by filtration and dried at suitable temperatures between 100 and 250° C. The added amount of surface-treatment medium is, for example, from approximately 1 to approximately 20% by weight.

In the context of the stabiliser compositions according to the invention, compounds of the general formula X can be used in an amount of up to approximately 50% by weight, for example up to approximately 30% by weight or up to approximately 15% by weight.

Also suitable as additives to the stabiliser compositions according to the invention are metal oxides, metal hydroxides and metal soaps of saturated, unsaturated, straight-chain or branched, aromatic, cycloaliphatic or aliphatic carboxylic acids or hydroxycarboxylic acids having especially from about 2 to about 22 carbon atoms.

As metal cations, the metal oxides, metal hydroxides or metal soaps suitable as additives have especially a divalent cation; the cations of calcium or zinc or mixtures thereof are especially suitable.

Examples of suitable carboxylic acid anions include anions of monovalent carboxylic acids, such as acetic acid, propionic acid, butyric acid, valeric acid, hexanoic acid, oenanthic acid, octanoic acid, neodecanoic acid, 2-ethylhexanoic acid, pelargonic acid, decanoic acid, undecanoic acid, dodecanoic acid, tridecanoic acid, myristic acid, palmitic acid, lauric acid, isostearic acid, stearic acid, 12-hydroxystearic acid, 9,10-dihydroxystearic acid, oleic acid, 3,6-dioxaheptanoic acid, 3,6,9-trioxadecanoic acid, behenic acid, benzoic acid, p-tert-butylbenzoic acid, dimethylhydroxybenzoic acid, 3,5-di-tert-butyl-4-hydroxybenzoic acid, toluic acid, dimethylbenzoic acid, ethylbenzoic acid, n-propylbenzoic acid, salicylic acid, p-tert-octylsalicylic acid, sorbic acid, anions of divalent carboxylic acids or monoesters thereof, such as oxalic acid, malonic acid, maleic acid, tartaric acid, cinnamic acid, mandelic acid, malic acid, glycolic acid, oxalic acid, salicylic acid, polyglycoldicarboxylic acids having a degree of polymerisation of from approximately 10 to approximately 12, phthalic acid, isophthalic acid, terephthalic acid or hydroxyphthalic acid, anions of tri- or tetra-valent carboxylic acids or mono-, di- or tri-esters thereof, as in hemimellitic acid, trimellitic acid, pyromellitic acid or citric acid, and also so-called overbased carboxylates as described, for example, in DE-A 41 06 404 or DE-A 40 02 988, the disclosure of the last-mentioned documents being regarded as part of the disclosure of this text.

Within the scope of a preferred embodiment of the present invention, it is preferable to use metal soaps having anions derived from saturated or unsaturated carboxylic acids or hydroxycarboxylic acids having from about 8 to about 20 carbon atoms. Special preference is given to stearates, oleates, laurates, palmitates, behenates, versatates, hydroxystearates, dihydroxystearates, p-tert-butyl benzoates or (iso)octanoates of calcium or zinc or mixtures of two or more thereof. Within the scope of a further preferred embodiment of the present invention, a stabiliser composition according to the invention has calcium stearate or zinc stearate or a mixture thereof.

A stabiliser composition according to the invention can comprise the mentioned metal oxides, metal hydroxides or metal soaps, or a mixture of two or more thereof, in an amount of up to approximately 50% by weight, for example in an amount of up to approximately 30% by weight.

A stabiliser composition according to the invention can furthermore comprise as thermostabiliser component an organotin compound or a mixture of two or more organotin compounds. Suitable organotin compounds are, for example, methyltin-tris(isooctyl-thioglycolate), methyltin-tris(isooctyl-3-mercaptopropionate), methyltin-tris(isodecyl-thioglycolate), dimethyltin-bis(isooctyl-thioglycolate), dibutyltin-bis(isooctyl-thioglycolate), monobutyltin-tris(isooctyl-thioglycolate), dioctyltin-bis(isooctyl-thioglycolate), monooctyltin-tris(isooctyl-thioglycolate) or dimethyltin-bis(2-ethylhexyl-β-mercaptopropionate).

Furthermore, in the context of the stabiliser compositions according to the invention it is possible to use the organotin compounds which are mentioned and the preparation of which is described on pages 18 to 29 of EP-A 0 742 259. Reference is expressly made to the above-mentioned disclosure, the compounds mentioned therein and their preparation being understood as being part of the disclosure of this text.

A stabiliser composition according to the invention can comprise the described organotin compounds in an amount of up to approximately 20% by weight, especially up to approximately 10% by weight.

Within the scope of a further embodiment of the present invention, a stabiliser composition according to the invention can comprise organic phosphite esters having from 1 to 3 organic radicals, two or more of which radicals may be identical or all of which may be different. Suitable organic radicals are, for example, linear or branched, saturated or unsaturated alkyl radicals having from 1 to 24 carbon atoms, unsubstituted or substituted alkyl radicals having from 6 to 20 carbon atoms or unsubstituted or substituted aralkyl radicals having from 7 to 20 carbon atoms. Examples of suitable organic phosphite esters are tris(nonylphenyl), trilauryl, tributyl, trioctyl, tridecyl, tridodecyl, triphenyl, octyldiphenyl, dioctylphenyl, tri(octylphenyl), tribenzyl, butyldicresyl, octyl-di(octylphenyl), tris(2-ethylhexyl), tritolyl, tris(2-cyclohexylphenyl), tri-α-naphthyl, tris(phenylphenyl), tris(2-phenylethyl), tris(dimethylphenyl), tricresyl or tris(p-nonylphenyl) phosphite or tristearyl sorbitol-triphosphite or mixtures of two or more thereof.

A stabiliser composition according to the invention can comprise the described phosphite compounds in an amount of up to approximately 30% by weight, especially up to approximately 10% by weight.

A stabiliser composition according to the invention can also comprise as additives blocked mercaptans, as mentioned on pages 4 to 18 of EP-A 0 742 259. Reference is expressly made to the disclosure in the specification indicated, which is understood as being part of the disclosure of this text.

A stabiliser composition according to the invention can comprise the described blocked mercaptans in an amount of up to approximately 30% by weight, especially up to approximately 10% by weight.

A stabiliser composition according to the invention can also comprise lubricants, such as montan wax, fatty acid esters, purified or hydrogenated natural or synthetic triglycerides or partial esters, polyethylene waxes, amide waxes, chloroparaffins, glycerol esters or alkaline earth soaps. Lubricants suitable for use are also described in “Kunststoffadditive”, R. Gächter/H. Müller, Carl Hanser Verlag, 3rd edition, 1989, pages 478-488. Also suitable as lubricants are, for example, fatty ketones, as described in DE 4,204,887, and also silicone-based lubricants, as mentioned, for example, in EP-A 0 259 783, or combinations thereof, as mentioned in EP-A 0 259 783. Reference is expressly made to the mentioned documents, the disclosure of which relating to lubricants is to be regarded as being part of the disclosure of this text.

A stabiliser composition according to the invention can comprise the described lubricants in an amount of up to approximately 70% by weight, especially up to approximately 40% by weight.

Also suitable as additives for stabiliser compositions according to the present invention are organic plasticisers.

Suitable as plasticisers are, for example, compounds from the group of phthalic acid esters, such as dimethyl, diethyl, dibutyl, dihexyl, di-2-ethylhexyl, di-n-octyl, diisooctyl, diisononyl, diisodecyl, dicyclohexyl, dimethylcyclohexyl, dimethyl glycol, dibutyl glycol, benzylbutyl or diphenyl phthalate and also mixtures of phthalates, for example mixtures of alkyl phthalates having from 7 to 9 or 9 to 11 carbon atoms in the ester alcohol or mixtures of alkyl phthalates having from 6 to 10 and 8 to 10 carbon atoms in the ester alcohol. Especially suitable in the sense of the present invention are dibutyl, dihexyl, di-2-ethylhexyl, di-n-octyl, diisooctyl, diisononyl, diisodecyl, diisotridecyl and benzylbutyl phthalate and also the mentioned mixtures of alkyl phthalates.

Also suitable as plasticisers are the esters of aliphatic dicarboxylic acids, especially the esters of adipic, azelaic or sebacic acid or mixtures of two or more thereof. Examples of such plasticisers are di-2-ethylhexyl adipate, diisooctyl adipate, diisononyl adipate, diisodecyl adipate, benzylbutyl adipate, benzyloctyl adipate, di-2-ethylhexyl azelate, di-2-ethylhexyl sebacate and diisodecyl sebacate. Within the scope of a further embodiment of the present invention preference is given to di-2-ethylhexyl acetate and diisooctyl adipate.

Also suitable as plasticisers are trimellitic acid esters, such as tri-2-ethylhexyl trimellitate, triisotridecyl trimellitate, triisooctyl trimellitate and also trimellitic acid esters having from 6 to 8, 6 to 10, 7 to 9 or 9 to 11 carbon atoms in the ester group or mixtures of two or more of the mentioned compounds.

Suitable plasticisers are also, for example, polymer plasticisers, as mentioned in “Kunststoffadditive”, R. Gächter/H. Müller, Carl Hanser Verlag, 3rd edition, 1989, chapter 5.9.6, pages 412-415, or “PVC Technology”, W. V. Titow, 4th Edition, Elsevier Publishers, 1984, pages 165-170. The starting materials most commonly used for the preparation of polyester plasticisers are, for example, dicarboxylic acids, such as adipic, phthalic, azelaic or sebacic acid, and diols, such as 1,2-propanediol, 1,3-butanediol, 1,4-butanediol, 1,6-hexanediol, neopentyl glycol or diethylene glycol or mixtures of two or more thereof.

Also suitable as plasticisers are phosphoric acid esters, such as those in “Taschenbuch der Kunststoffadditive”, chapter 5.9.5, pages 408-412. Examples of suitable phosphoric acid esters are tributyl phosphate, tri-2-ethylbutyl phosphate, tri-2-ethylhexyl phosphate, trichloroethyl phosphate, 2-ethyl-hexyl-di-phenyl phosphate, triphenyl phosphate, tricresyl phosphate or trixylenyl phosphate, or mixtures of two or more thereof.

Also suitable as plasticisers are chlorinated hydrocarbons (paraffins) or hydrocarbons as described in “Kunststoffadditive”, R. Gächter/H. Müller, Carl Hanser Verlag, 3rd edition, 1989, chapter 5.9.14.2, pages 422-425, and chapter 5.9.14.1, page 422.

A stabiliser composition according to the invention can comprise the described plasticisers in an amount of up to approximately 99.5% by weight, especially up to approximately 30% by weight, up to approximately 20% by weight or up to approximately 10% by weight. Within the scope of a preferred embodiment of the present invention, the lower limit for the described plasticisers as constituent of the stabiliser compositions according to the invention is approximately 0.1% by weight or more, for example approximately 0.5% by weight, 1% by weight, 2% by weight or 5% by weight.

Pigments are also suitable as constituents of the stabiliser compositions according to the invention. Examples of suitable inorganic pigments are titanium dioxide, carbon black, Fe₂O₃, Sb₂O₃, (Ba, Sb)O₂, Cr₂O₃, spinels, such as cobalt blue and cobalt green, Cd (S, Se) or ultramarine blue. Suitable organic pigments are, for example, azo pigments, phthalocyanine pigments, quinacridone pigments, perylene pigments, diketopyrrolopyrrole pigments and anthraquinone pigments.

A stabiliser composition according to the invention can also comprise fillers, such as those described on pages 393 to 449 of “Handbook of PVC Formulating”, E. J. Wickson, John Wiley & Sons, Inc., 1993, or reinforcing agents, such as those described on pages 549 to 615 of “Taschenbuch der Kunststoffadditive”, R. Gächter/H. Müller, Carl Hanser Verlag, 1990. Especially suitable fillers or reinforcing agents are, for example, calcium carbonate (chalk), dolomite, wollastonite, magnesium oxide, magnesium hydroxide, silicates, glass fibres, talc, kaolin, chalk, carbon black or graphite, wood flour or other renewable raw materials. Within the scope of a preferred embodiment of the present invention, a stabiliser composition according to the invention comprises chalk.

Within the scope of a further embodiment of the present invention, the stabiliser compositions according to the invention can comprise antioxidants, UV absorbers and light stabilisers or blowing agents. Suitable antioxidants are described, for example, on pages 33 to 35 of EP-A 1 046 668. Suitable UV absorbers and light stabilisers are mentioned therein on pages 35 and 36. Reference is expressly made to both disclosures, the disclosures being regarded as part of this text.

Suitable blowing agents are, for example, organic azo and hydrazo compounds, tetrazoles, oxazines, isatoic anhydride, salts of citric acid, for example ammonium citrate, and also sodium carbonate and sodium hydrogen carbonate. Especially suitable are, for example, ammonium citrate, azodicarbonamide or sodium hydrogen carbonate or mixtures of two or more thereof.

A stabiliser composition according to the invention can also comprise impact strength modifiers and processing aids, gelling agents, antistatics, biocides, metal deactivators, optical brighteners, flame retardants and also antifogging compounds. Suitable compounds of those classes of compound are described, for example, in “Kunststoff Additive”, R. Keβler/H. Müller, Carl Hanser Verlag, 3rd edition, 1989 and also in “Handbook of PVC Formulating”, E. J. Wilson, J. Wiley & Sons, 1993.

Within the scope of preferred embodiments of the present invention, a stabiliser composition according to the invention can have a complex composition. In principle, it is possible to use as constituent of the compositions according to the invention essentially the compounds already mentioned in this text. A stabiliser composition according to the invention can accordingly comprise, for example, exclusively compounds that are effective in respect of the initial colour or the colour stability. A stabiliser composition according to the invention can also comprise, however, further of the above-mentioned compounds, especially additives, that affect the processability of halogen-containing plastics or the properties of moulded articles produced from such plastics.

A stabiliser composition according to the invention accordingly has, for example, the constituents listed by way of example in Tables 1 to 4 below. All the data below are given in % by weight, based on the total stabiliser composition.

TABLE 1

| | No. 1 | No. 2 | No. 3 | No. 4 | No. 5 | No. 6 | No. 7 | No. 8 |
|---|---|---|---|---|---|---|---|---|
| (Di)arylthiourea | 15-50 | 15-50 | 15-50 | 2-10 | 2-10 | 2-10 | 2-10 | 2-10 |
| Aminocrotonic acid | 15-50 | 15-50 | 15-50 | 2-10 | | 2-10 | 2-10 | 2-10 |
| ester | | | | | | | | |
| Perchlorate | | | | | 2-10 | 2-10 | 2-10 | 2-10 |
| (supported, 10%) | | | | | | | | |
| Hydrocalumite/ | 20-40 | | 20-40 | 40-80 | 40-80 | 40-80 | 40-80 | |
| hydrotalcite/zeolite | | | | | | | | |
| Inorganic acid | | | | | | | | 40-80 |
| scavenger (e.g. | | | | | | | | |
| calcium hydroxide) | | | | | | | | |
| Ca and/or Zn soap | | 10-30 | 10-30 | 10-40 | 10-40 | 10-40 | 10-40 | 10-40 |

TABLE 2

| | No. 9 | No. 10 | No. 11 | No. 12 | No. 13 | No. 14 | No. 15 | No. 16 |
|---|---|---|---|---|---|---|---|---|
| (Di)arylthiourea | 2-10 | 15-50 | 5-10 | 2-10 | 2-10 | 2-10 | 2-10 | 2-10 |
| Aminocrotonic acid | 2-10 | | 5-10 | | 2-10 | 2-10 | 2-10 | 2-10 |
| ester | | | | | | | | |
| Perchlorate (supported, | 2-10 | 15-50 | | 5-20 | 5-20 | 5-20 | 5-20 | 2-20 |
| 10%) | | | | | | | | |
| Hydrocalumite/ | 40-80 | 20-40 | | | | | | 4-10 |
| hydrotalcite/zeolite | | | | | | | | |
| Ca and/or Zn soap | 10-40 | 10-30 | 5-25 | 5-25 | 5-25 | 5-25 | 5-25 | 5-25 |
| Internal lubricants (e.g. | | | 65-80 | 65-80 | 65-80 | 65-80 | 65-80 | 65-80 |
| fatty acid esters) | | | | | | | | |
| Phosphite esters | | | | | | 5-20 | | |
| β-Diketones | | | | | | | 5-20 | 5-20 |
| Antioxidants | 0.2-5 | | | | | | | |

TABLE 3

| | No. 17 | No. 18 | No. 19 | No. 20 | No. 21 | No. 22 | No. 23 | No. 24 |
|---|---|---|---|---|---|---|---|---|
| (Di)Arylthiourea | | 2-10 | | 8-20 | 5-15 | 5-15 | 5-15 | 5-15 |
| Substituted mercapto- | 2-10 | | 2-10 | | | | | |
| benzothiazole | | | | | | | | |
| Aminocrotonic acid ester | 2-10 | | | 8-20 | 5-15 | | 5-15 | 5-15 |
| Aminosalicylate | | 2-10 | 2-10 | | | | | |
| Perchlorate (supported, | 5-20 | 5-20 | 5-20 | | | 1-10 | 1-10 | 1-10 |
| 10%) | | | | | | | | |
| Hydrocalumite/ | | | | 20-40 | 20-40 | 10-30 | 10-30 | |
| hydrotalcite/zeolite | | | | | | | | |
| Inorganic acid scavenger | | | | | | 10-30 | 10-30 | 20-40 |
| (e.g. calcium hydroxide) | | | | | | | | |
| Ca and/or Zn soap | 5-25 | 5-25 | 5-25 | 10-20 | 10-30 | 10-30 | 10-30 | 10-30 |
| Internal lubricants (e.g. | 65-80 | 65-80 | 65-80 | 10-20 | 10-30 | 10-30 | 10-30 | 10-30 |
| fatty acid esters) | | | | | | | | |
| External lubricants (e.g. | | | | 10-20 | 10-30 | 10-30 | 10-30 | 10-30 |
| PE waxes, oxidised PE | | | | | | | | |
| waxes) | | | | | | | | |
| Polyol (e.g. trimethylol- | | | | | | | | 5-15 |
| propane or sorbitol) | | | | | | | | |

TABLE 4

| | No. 24 | No. 25 | No. 26 | No. 27 | No. 28 | No. 29 | No. 30 |
|---|---|---|---|---|---|---|---|
| (Di)Arylthiourea | 5-15 | 5-15 | 5-15 | 5-15 | | 5-15 | |
| Substituted mercapto- | | | | | 5-15 | | 5-15 |
| benzothiazole | | | | | | | |
| Aminocrotonic acid ester | 5-15 | 5-15 | 5-15 | 5-15 | 5-15 | | |
| Aminosalicylate | | | | | | 5-15 | 5-15 |
| Perchlorate (supported, | 1-10 | 1-10 | 1-10 | 1-10 | 1-10 | 1-10 | 1-10 |
| 10%) | | | | | | | |
| Hydrocalumite/ | | | | 10-30 | 10-30 | 10-30 | 10-30 |
| hydrotalcite/zeolite | | | | | | | |
| Inorganic acid scavenger | 20-40 | 20-40 | 20-40 | 10-30 | 10-30 | 10-30 | 20-40 |
| (e.g. calcium hydroxide) | | | | | | | |
| Ca and/or Zn soap | 10-30 | 10-30 | 10-30 | 10-30 | 10-30 | 10-30 | 10-30 |
| Internal lubricants (e.g. | 10-30 | 10-30 | 10-30 | 10-30 | 10-30 | 10-30 | 10-30 |
| fatty acid esters) | | | | | | | |
| External lubricants (e.g. | 10-30 | 10-30 | 10-30 | 10-30 | 10-30 | 10-30 | 10-30 |
| PE waxes, oxidised PE | | | | | | | |
| waxes) | | | | | | | |
| Polyol (e.g. trimethylol- | 5-15 | 5-15 | 5-15 | 5-15 | 5-15 | 5-15 | 5-15 |
| Propane or sorbitol) | | | | | | | |
| Phosphite esters | | 5-15 | | | | | |
| β-Diketones | | | 5-15 | | | | |

The stabiliser compositions according to the invention are suitable for the stabilisation of halogen-containing polymers.

Examples of such halogen-containing polymers are polymers of vinyl chloride, vinyl resins containing vinyl chloride units in the polymer backbone, copolymers of vinyl chloride and vinyl esters of aliphatic acids, especially vinyl acetate, copolymers of vinyl chloride with esters of acrylic and methacrylic acid or acrylonitrile or mixtures of two or more thereof, copolymers of vinyl chloride with diene compounds or unsaturated dicarboxylic acids or anhydrides thereof, for example copolymers of vinyl chloride with diethyl maleate, diethyl fumarate or maleic anhydride, post-chlorinated polymers and copolymers of vinyl chloride, copolymers of vinyl chloride and vinylidene chloride with unsaturated aldehydes, ketones and other compounds such as acrolein, crotonaldehyde, vinyl methyl ketone, vinyl methyl ether, vinyl isobutyl ether and the like, polymers and copolymers of vinylidene chloride with vinyl chloride and other polymerisable compounds, such as those already mentioned above, polymers of vinyl chloroacetate and dichlorodivinyl ether, chlorinated polymers of vinyl acetate, chlorinated polymeric esters of acrylic acid and a-substituted acrylic acids, chlorinated polystyrenes, for example polydichlorostyrene, chlorinated polymers of ethylene, polymers and post-chlorinated polymers of chlorobutadiene and copolymers thereof with vinyl chloride and also mixtures of two or more of the mentioned polymers or polymer mixtures that contain one or more of the above-mentioned polymers.

Also suitable for stabilisation with the stabiliser compositions according to the invention are the graft polymers of PVC with EVA, ABS or MBS. Preferred substrates for such graft copolymers are also the afore-mentioned homo- and co-polymers, especially mixtures of vinyl chloride homopolymers with other thermoplastic or elastomeric polymers, especially blends with ABS, MBS, NBR, SAN, EVA, CPE; MBAS, PAA (polyalkyl acrylate), PAMA (polyalkyl methacrylate), EPDM, polyamides or polylactones.

Likewise suitable for stabilisation with the stabiliser compositions according to the invention are mixtures of halogenated and non-halogenated polymers, for example mixtures of the above-mentioned non-halogenated polymers with PVC, especially mixtures of polyurethanes and PVC.

Furthermore, it is also possible for recyclates of chlorine-containing polymers to be stabilised with the stabiliser compositions according to the invention, in principle any recyclates of the above-mentioned halogenated polymers being suitable for this purpose. PVC recyclate, for example, is suitable in the context of the present invention.

The present invention therefore relates also to a polymer composition at least comprising a halogenated polymer and a stabiliser composition according to the invention.

Within the scope of a preferred embodiment of the present invention, a polymer composition according to the invention comprises the stabiliser composition according to the invention in an amount of from 0.1 to 20 phr, especially from approximately 0.5 to approximately 15 phr or from approximately 1 to approximately 12 phr. The unit phr represents “per hundred resin” and thus relates to parts by weight per 100 parts by weight of polymer.

A polymer composition according to the invention preferably comprises as halogenated polymer as least a proportion of PVC, the PVC content being especially at least approximately 20% by weight, preferably at least approximately 50% by weight, for example at least approximately 80% by weight or at least approximately 90% by weight. Within the scope of an especially preferred embodiment of the present invention, a polymer composition according to the invention has, for example, the constituents mentioned in the following Table 5 (all data in phr):

TABLE 5

| Polymer | | | | | | | | |
|---|---|---|---|---|---|---|---|---|
| compositions | P1 | P2 | P3 | P4 | P5 | P6 | P7 | P8 |
| PVC | 100 | 100 | 100 | 100 | 100 | 100 | 100 | 100 |
| Polyacrylate | | | | | | 0.5-10 | 0.5-10 | 0.5-10 |
| Filler (chalk) | 0-70 | 0-50 | | 1.0-10 | 1.0-10 | 1.0-10 | 1.0-10 | 1.0-10 |
| Plasticiser | 40-70 | 0-50 | 40-70 | | | | | |
| Pigment (TiO₂) | | | | | 1.0-10 | 1.0-10 | 1.0-10 | 1.0-10 |
| Internal/external | | | | | | 0.5-4 | | |
| lubricants | | | | | | | | |
| Inorganic acid | | | | | | | 0.5-4 | |
| scavenger | | | | | | | | |
| Examples 1-10 | | | | | | 2.0-7 | | |
| Examples 11-19 | | | | | | | 2.0-7 | |
| Examples 20-30 | | | | 2.0-7 | 2.0-7 | | | 2.0-7 |
| Examples 1-19 | 2.5-12 | 2.5-12 | 2.5-12 | | | | | |

The present invention relates also to a method of stabilising halogen-containing polymers in which a halogen-containing polymer or a mixture of two or more halogen-containing polymers or a mixture of one or more halogen-containing polymers and one or more halogen-free polymers is mixed with a stabiliser composition according to the invention.

The mixing together of polymer or polymers and the stabiliser composition according to the invention can in principle be effected at any time before or during the processing of the polymer. For example, the stabiliser composition can be mixed into the polymer, which is in powder or granule form, prior to processing. It is equally possible, however, to add the stabiliser composition to the polymer or polymers in the softened or molten state, for example during processing in an extruder, in the form of an emulsion or dispersion, in the form of a pasty mixture, in the form of a dry mixture or in the form of a solution or melt.

A polymer composition according to the invention can be brought into a desired form in known manner. Suitable methods are, for example, calendering, extrusion, injection-moulding, sintering, extrusion blowing or plastisol processes. A polymer composition according to the invention can also be used, for example, in the production of foamed materials. In principle, the polymer compositions according to the invention are suitable for the production of hard or soft PVC.

A polymer composition according to the invention can be processed to form moulded articles. The present invention therefore relates also to moulded articles, at least comprising a stabiliser composition according to the invention or a polymer composition according to the invention.

The term “moulded article” in the context of the present invention in principle includes any three-dimensional structures that can be produced from a polymer composition according to the invention. In the context of the present invention the term “moulded article” includes, for example, wire sheathings, automobile components, for example automobile components such as are used in the interior of the automobile, in the engine space or on the outer surfaces, cable insulators, decorative films, agricultural films, hoses, shaped sealing elements, office films, hollow bodies (bottles), packaging films, (deep-draw films), blown films, tubes, foamed materials, heavy duty profiles (window frames), lightweight profiles, structural profiles, sidings, fittings, plates, foamed panels, co-extrudates having a recycled core, or housings for electrical apparatus or machinery, for example computers or household appliances. Further examples of moulded articles that can be produced from a polymer composition according to the invention are synthetic leather, floor coverings, textile coatings, wallcoverings, coil coatings and underseals for motor vehicles.

The invention is explained in greater detail by Examples.

### EXAMPLES

1. Formulations

The following formulations have been tested for their stabiliser action:

### Example 1

### Formulations For Comparing PVC Without Diphenylthiourea/With Diphenylthiourea/Combinations

| | Formulation | | | | |
|---|---|---|---|---|---|
| | 1 | 2 | 3 | 4 | 5 |
| PVC | 100.00 | 100.00 | 100.00 | 100.00 | 100.00 |
| Chalk | 2.00 | 2.00 | 2.00 | 2.00 | 2.00 |
| Calcium stearate | 0.60 | 0.60 | 0.60 | 0.60 | 0.60 |
| Zeolite | 1.00 | 1.00 | 1.00 | 1.00 | 1.00 |
| Calcium hydroxide | 0.30 | 0.30 | 0.30 | 0.30 | 0.30 |
| Perchlorate (10%) | | | 0.20 | | 0.20 |
| Aminocrotonate | | | | 0.30 | 0.30 |
| Fatty acid ester | 0.60 | 0.60 | 0.60 | 0.60 | 0.60 |
| Diphenylthiourea | | 0.30 | 0.30 | 0.30 | 0.30 |
| PE wax | 0.50 | 0.50 | 0.50 | 0.50 | 0.50 |
| Oxidised PE wax | 0.30 | 0.30 | 0.30 | 0.30 | 0.30 |
| Titanium dioxide | 0.10 | 0.10 | 0.10 | 010 | 010 |

### Example 2

### Comparison Of The UV Stabilisation Of A Stabiliser Composition According To The Invention With A Stabiliser Composition Having Aminouracil

TABLE 2.1

| | Formulation | | |
|---|---|---|---|
| | 6 | 7 | 8 |
| PVC | 100.00 | 100.00 | 100.00 |
| Chalk | 2.00 | 2.00 | 2.00 |
| Calcium stearate | 0.60 | 0.60 | 0.60 |
| Zeolite | 0.75 | 0.75 | 0.75 |
| Calcium hydroxide | 0.20 | 0.20 | 0.20 |
| Perchlorate (10%) | 0.10 | 0.10 | 0.10 |
| Aminocrotonate | 0.20 | | |
| Fatty acid ester | 0.60 | 0.60 | 0.60 |
| Diphenylthiourea | 0.10 | | |
| PE wax | 0.50 | 0.50 | 0.50 |
| Oxidised PE wax | 0.30 | 0.30 | 0.30 |
| Titanium dioxide | 0.10 | 0.10 | 0.10 |
| Aminouracil | | 0.30 | 0.10 |

### Example 3

### Comparisons With Various Combinations Of Diphenylthiourea/Aminocrotonate With Other Compounds From The Prior Art

TABLE 3.1

| | Formulation | | | | |
|---|---|---|---|---|---|
| | 9 | 10 | 11 | 12 | 13 |
| PVC | 100.00 | 100.00 | 100.00 | 100.00 | 100.00 |
| Chalk | 2.00 | 2.00 | 2.00 | 2.00 | 2.00 |
| Calcium stearate | 0.60 | 0.60 | 0.60 | 0.60 | 0.60 |
| Zeolite | 0.75 | 0.75 | 0.75 | 0.75 | 0.75 |
| Calcium hydroxide | 0.20 | 0.20 | 0.20 | 0.20 | 0.20 |
| Perchlorate (10%) | 0.10 | 0.10 | 0.10 | 0.10 | 0.10 |
| Aminocrotonate | 0.20 | 0.20 | 0.20 | 0.20 | 0.20 |
| Fatty acid ester | 0.60 | 0.60 | 0.60 | 0.60 | 0.60 |
| Diphenylthiourea | 0.30 | | | | |
| PE wax | 0.50 | 0.50 | 0.50 | 0.50 | 0.50 |
| Oxidised PE wax | 0.30 | 0.30 | 0.30 | 0.30 | 0.30 |
| Titanium dioxide | 0.10 | 0.10 | 0.10 | 0.10 | 0.10 |
| Bisphenol A - glycidyl | | | | | |
| ether | | | | | |
| Di-tert-butyl phenol | | 0.30 | | | |
| Polyethylene glycol | | | 0.30 | | |
| Phenylindole | | | | 0.30 | |
| Dehydroacetic acid | | | | | 0.30 |

TABLE 3.2

| | Formulation | | | | |
|---|---|---|---|---|---|
| | 14 | 15 | 16 | 17 | 18 |
| PVC | 100.00 | 100.0 | 100.00 | 100.00 | 100.0 |
| Chalk | 2.00 | 2.00 | 2.00 | 2.00 | 2.00 |
| Calcium stearate | 0.60 | 0.60 | 0.60 | 0.60 | 0.60 |
| Zeolite | 0.75 | 0.75 | 0.75 | 0.75 | 0.75 |
| Calcium hydroxide | 0.20 | 0.20 | 0.20 | 0.20 | 0.20 |
| Perchlorate (10%) | 0.10 | 0.10 | 0.10 | 0.10 | 0.10 |
| Aminocrotonate | 0.20 | 0.20 | 0.20 | 0.20 | 0.20 |
| Fatty acid ester | 0.60 | 0.60 | 0.60 | 0.60 | 0.60 |
| Diphenylthiourea | 0.30 | | | | |
| PE wax | 0.50 | 0.50 | 0.50 | 0.50 | 0.50 |
| Oxidised PE wax | 0.30 | 0.30 | 0.30 | 0.30 | 0.30 |
| Titanium dioxide | 0.10 | 0.10 | 0.10 | 0.10 | 0.10 |
| Bisphenol A - glycidyl | 0.30 | 0.30 | 0.30 | 0.30 | 0.30 |
| ether | | | | | |
| Di-tert-butyl phenol | | 0.30 | | | |
| Polyethylene glycol | | | 030 | | |
| Phenylindole | | | | 030 | |
| Dehydroacetic acid | | | | | 030 |

2. Tests

Dryblends prepared in accordance with the given formulations were processed to form sheets on a laboratory roller mechanism at 190° C. within a period of 3 minutes. The thermal stability of the resulting PVC testpieces was statically determined quantatively in the Congo red test according to DIN VDE 0472/T614 as well as qualitatively assessed visually in a Mathis oven (200° C., advance every 5 minutes). For determining the initial colour, the PVC sheet was processed further at 180° C. to form compressed panels. Their colour was measured using the CIE-LAB colour system. For determining the UV stability, testpieces were irradiated for 24, 48, 72 hours with artificial light generated by OSRAM-ULTRA-VITALUX incandescent lamps (UV-A radiation) in a ARA-LUX apparatus. The colour of the test bodies was then measured in the CIE-LAB system.

5 3. Results

### Example 1

| | | | | | Assessment | Assessment |
|---|---|---|---|---|---|---|
| | HCl | | | | initial colour | colour retention |
| | (minutes) | L value | a value | b value | (visual) | (visual) |
| Formulation 1 | 13 | 47.3 | 19.1 | 10.6 | 5 | 6 |
| Formulation 2 | 8 | 77.5 | 6.4 | 22.3 | 3 | 5 |
| Formulation 3 | 18 | 83.3 | 1.9 | 21.9 | 2 | 2 |
| Formulation 4 | 11 | 86.4 | −0.7 | 17.3 | 2 | 2 |
| Formulation 5 | 22 | 87.0 | −0.5 | 14.7 | 1 | 1 |

### Example 2

| | | Before irradiation | | | |
|---|---|---|---|---|---|
| | | | | | Colour |
| | HCl | | | | assessment |
| | (minutes) | L value | a value | b value | (visual) |
| Formulation 6 | 19 | 89.2 | −0.6 | 10.5 | 1 |
| Formulation 7 | 19 | 88.0 | −0.6 | 10.8 | 1 |
| Formulation 8 | 19 | 87.3 | −1.2 | 16.3 | 3 |
| | | After irradiation (72 hours) | | | |
| | | | | | Colour |
| | | | | | assessment |
| | | L value | a value | b value | (visual) |
| Formulation 6 | | 86.0 | 1.3 | 16.4 | 1 |
| Formulation 7 | | 82.7 | 2.2 | 21.1 | 3 |
| Formulation 8 | | 82.9 | 1.9 | 19.1 | 3 |

### Example 3

| | | | | | Assessment | Assessment |
|---|---|---|---|---|---|---|
| | HCl | | | | initial colour | colour retention |
| | (minutes) | L value | a value | b value | (visual) | (visual) |
| Formulation 9 | 19 | 88.8 | −0.2 | 11.3 | 1 | 1 |
| Formulation 10 | 21 | 83.2 | 1.2 | 32.4 | 4 | 4 |
| Formulation 11 | 16 | 83.5 | 1.5 | 32.6 | 4 | 4 |
| Formulation 12 | 30 | 86.1 | −0.6 | 16.4 | 2 | 3 |
| Formulation 13 | 18 | 84.3 | 0.3 | 26.8 | 4 | 4 |
| Formulation 14 | 19 | 86.5 | 0.0 | 12.3 | 1 | 1 |
| Formulation 15 | 25 | 84.9 | 1.1 | 27.7 | 4 | 4 |
| Formulation 16 | 22 | 85.1 | −0.1 | 29.7 | 4 | 4 |
| Formulation 17 | 34 | 87.4 | −0.8 | 16.9 | 3 | 3 |
| Formulation 18 | 22 | 83.6 | −0.3 | 27.7 | 4 | 4 |

1. Stabiliser composition, at least comprising a compound having a mercapto-functional sp²-hybridised carbon atom, the compound having a mercapto-functional sp²-hybridised carbon atom not being a cyanoacetylurea, and a halogen-containing salt of an oxy acid.

2. Stabiliser composition, at least comprising a compound having a mercapto-functional sp²-hybridised carbon atom and a halogen-containing salt of an oxy acid or a carbazole or at least one carbazole derivative or 2,4-pyrrolidinedione or at least one 2,4-pyrrolidinedione derivative or at least one compound having a structural element of the general formula I 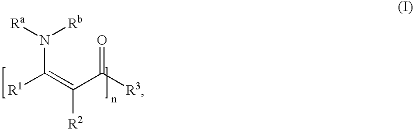
wherein n is a number from 1 to 100,000, the radicals R^{a}, R^{b}, R¹ and R² are each independently of the others hydrogen, an unsubstituted or substituted linear or branched, saturated or unsaturated aliphatic alkyl radical having from 1 to 44 carbon atoms, an unsubstituted or substituted saturated or unsaturated cycloalkyl radical having from 6 to 44 carbon atoms, an unsubstituted or substituted aryl radical having from 6 to 44 carbon atoms or an unsubstituted or substituted aralkyl radical having from 7 to 44 carbon atoms, or the radical R¹ is an unsubstituted or substituted acyl radical having from 2 to 44 carbon atoms or the radicals R¹ and R² are linked to form an aromatic or heterocyclic system and wherein the radical R³ is hydrogen, an unsubstituted or substituted, linear or branched, saturated or unsaturated aliphatic alkyl or alkylene radical or oxyalkyl or oxyalkylene radical or mercaptoalkyl or mercaptoalkylene radical or aminoalkyl or aminoalkylene radical having from 1 to 44 carbon atoms, an unsubstituted or substituted saturated or unsaturated cycloalkyl or cycloalkylene radical or oxycycloalkyl or oxycycloalkylene radical or mercaptocycloalkyl or mercaptocycloalkylene radical or aminocycloalkyl or aminocycloalkylene radical having from 6 to 44 carbon atoms or an unsubstituted or substituted aryl or arylene radical having from 6 to 44 carbon atoms or an ether or thioether radical having from 1 to 20 O or S atoms or O and S atoms, or is a polymer that is bonded to the structural element in brackets by way of O, S, NH, NR^{a} or CH₂C(O), or the radical R³ is so linked to the radical R¹ that in total an unsubstituted or substituted, saturated or unsaturated heterocyclic ring system having from 4 to 24 carbon atoms is formed, the radical R¹ in a ring system with R³ not being NH or NR^{a}, or a mixture of two or more of the mentioned compounds.

3. Stabiliser composition according to claim 1 or 2, characterised in that it has at least one compound having a mercapto-functional sp²-hybridised carbon atom and has a halogen-containing salt of an oxy acid and at least one compound having a structural element of the general formula I.

4. Stabiliser composition according to any one of claims 1 to 3, characterised in that as the halogen-containing salt of an oxy acid it comprises a perchlorate or a mixture of two or more perchlorates.

5. Stabiliser composition according to any one of claims 1 to 4, characterised in that it comprises a carbazole of the general formula III 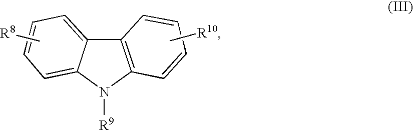
wherein the radicals R⁸, R⁹ and R¹⁰ are each independently of the others hydrogen, a linear or branched, saturated or unsaturated, unsubstituted or substituted alkyl radical having from 1 to 24 carbon atoms, a saturated or unsaturated, unsubstituted or substituted cycloalkyl radical having from 6 to 24 carbon atoms or an unsubstituted or substituted aryl radical having from 6 to 24 carbon atoms.

6. Stabiliser composition according to any one of claims 1 to 5, characterised in that it comprises a 2,4-pyrrolidinedione of the general formula IV 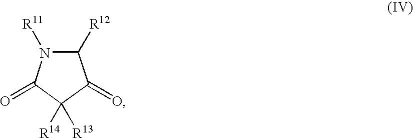
wherein the radicals R⁷ to R⁹ are each independently of the others hydrogen, a linear or branched, saturated or unsaturated, unsubstituted or substituted alkyl radical having from 1 to 24 carbon atoms, an unsubstituted or substituted, saturated or unsaturated cycloalkyl radical having from 6 to 24 carbon atoms or an unsubstituted or substituted aryl radical having from 6 to 24 carbon atoms, or a mixture of two or more thereof.

7. Stabiliser composition according to any one of claims 2 to 6, characterised in that as the compound of the general formula I it comprises a derivative of aminocrotonic acid or a compound of the general formula V 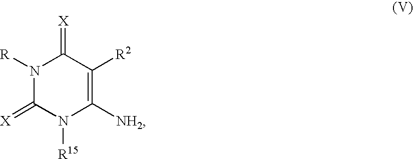
wherein the radicals R and R² have the meanings given in claim 1 and the radical R¹⁵ is hydrogen, an unsubstituted or substituted linear or branched, saturated or unsaturated aliphatic hydrocarbon radical having from 1 to 44 carbon atoms, an unsubstituted or substituted saturated or unsaturated cycloaliphatic hydrocarbon radical having from 6 to 44 carbon atoms or an unsubstituted or substituted aromatic hydrocarbon radical having from 6 to 44 carbon atoms, or a mixture of two or more thereof.

8. Stabiliser composition according to any one of claims 1 to 7, characterised in that it comprises at least one further additive.

9. Polymer composition, at least comprising a halogenated polymer and a stabiliser composition according to any one of claims 1 to 8.

10. Polymer composition according to claim 8, characterised in that it comprises a stabiliser composition according to any one of claims 1 to 9 in an amount of from 0.1 to 10% by weight.

11. Use of a stabiliser composition according to any one of claims 1 to 8 or a polymer composition according to either one of claims 9 and 10 in the production of polymeric moulded articles or surface-coating media.

12. Method of stabilising halogen-containing polymers in which a halogen-containing polymer or a mixture of two or more halogen-containing polymers or a mixture of one or more halogen-containing polymers and one or more halogen-free polymers is mixed with a stabiliser composition according to any one of claims 1 to 8.

13. Moulded article, at least comprising a stabiliser composition according to any one of claims 1 to 8 or a polymer composition according to either one of claims 9 and 10.
